(19) United States
(12) Patent Application Publication
(10) Pub. No.: US 2013/0283892 A1
(43) Pub. Date: Oct. 31, 2013

(54) CAVITY RESONATOR

(71) Applicant: Alan Parker, Abingdon (GB)

(72) Inventor: Alan Parker, Abingdon (GB)

(21) Appl. No.: 13/812,313

(22) PCT Filed: Jul. 22, 2011
(86) PCT No.: PCT/EP2011/062682

§ 371 Date: Jul. 2, 2013

(30) Foreign Application Priority Data
Jul. 26, 2010 (GB) 1012516.9

(51) Int. Cl. G01N 27/00; H01P 7/06

(52) U.S. Cl. CPC G01N 27/00; H01P 7/06
USPC 73/61.49; 333/227

(57) ABSTRACT

Cavity resonator comprising: a cavity having a fluid entrance and a fluid exit forming a fluid flow path through the cavity. A shorting plate within the cavity arranged within the fluid flow path. The cavity resonator may be used in a system for detecting properties of a fluid, where the system also comprises a fluid supply, a high frequency supply, and a detector for detecting one or more resonant frequencies of the cavity resonator.

### FIELD OF THE INVENTION

The present invention relates to a cavity resonator and in particular a cavity resonator for use at microwave frequencies and also a method for using the cavity resonator to detect properties of a flowing fluid.

### BACKGROUND OF THE INVENTION

Measuring impurities such as water present in crude oil, can involve taking samples along a pipeline and carrying out offline measurements of a flowing fluid. However, by the time that the results of these measurements are obtained the composition of the fluid flowing in that particular section of pipeline may have changed. For example, it is common for periodic slugs of water or gas or other material to pass along the pipeline especially following extraction out of the ground or pumped out of a tanker.

“Microwave Semisectorial and Other Resonator Sensors for Measuring Material under Flow” Ebbe Nyfors, Chapter 10 of “Electromagnetic Aquametry”, edited by Klaus Kupfer, Springer Berlin 2005, describes the use of inline wet gas meters used to detect the presence of water flowing from an oil well. A V-cone is attached to a pipe wall and used as a microwave resonator with microwave probes added to couple microwave energy into the pipe. However, this configuration is sensitive mostly to the water volume fraction of the fluid flowing in the well pipe. Further measurements of pressure, volume and temperature are required to provide information used to infer the chemical composition of the hydrocarbon fraction. This increases complexity and reduces accuracy.

Therefore, there is required a cavity resonator and method of operation that overcomes these drawbacks.

### SUMMARY OF THE INVENTION

A cavity resonator is provided that allows a fluid to pass through it. The flowing fluid therefore changes the electrical properties of the cavity resonator and these changes are detected to provide information regarding physical properties and composition of the fluid.

An inner or centre conductor may be incorporated into the cavity to change its electrical characteristics. Preferably, the inner conductor is located along an axis of the cavity.

A shorting plate or member is located within the fluid flow path within cavity resonator. The shorting plate may be provided with apertures or holes to allow the fluid to pass through. The inner conductor may also be in electrical contact or integral with the shorting plate. Therefore, the inner conductor is shorted to the body or walls of the cavity resonator.

The shorting plate allows increased flexibility in coupling radio frequency (RF) energy into the cavity resonator. For example, the resonant frequency may be increased or doubled compared with a non-shorted device. The shorting plate also provides greater frequency dispersion between modes. This improves the measurements of complex fluids, which may require detection of changes in the complex electrical permittivity of the flowing fluid with frequency.

Where the cavity resonator is cylindrical, the shorting plate may be circular or annular. This may provide good electrical contact with the inner walls or the cavity resonator. For other shaped cavity resonators (e.g. square cross-section) the shorting plate may have a corresponding shape.

In accordance with a first aspect of the present invention there is provided a cavity resonator comprising:

a cavity having a fluid entrance and a fluid exit forming a fluid flow path through the cavity; and

a shorting plate within the cavity arranged within the fluid flow path.

Preferably, the shorting plate comprises one or more apertures for fluid to pass through. Other routes may be provided for the flowing fluid.

Preferably, the cavity or body of the cavity is formed from a conductive material.

Optionally, the cavity is cylindrical. Other shapes, such as square or rectangular profile shapes may be used.

Preferably, the cavity resonator further comprises an inner conductor. The inner or centre conductor may also be cylindrical and may extend the full or part of the way through the cavity. The inner conductor may alternatively provide a capacitively loaded cavity by having a gap in the middle or centre of the inner conductor.

Preferably, the inner conductor may be coaxial with the cavity.

Preferably, the inner conductor may be in contact with the shorting plate. This may be an electrical or physical contact. Therefore, the shorting plate will provide a short circuit at least at the frequencies of use, between the inner or centre conductor and the body or wall of the cavity.

Optionally, the cavity may be a quarter wavelength cavity. Other configurations may be used depending on the particular frequency applied to the device.

Optionally, the shorting plate may be annular, circular or other shape conforming to the inner surface of the cavity.

Optionally, the cavity is open ended. Optionally, the cavity resonator may further comprise non-conductive end plates.

Preferably, the cavity resonator may be configured to resonate at 600 MHz and above.

Preferably, the cavity resonator may be configured to resonate at multiple frequencies and/or modes.

According to a second aspect there is provided a system for detecting properties of a fluid comprising; a cavity resonator as described above; a fluid supply; a high frequency supply; and a detector for detecting one or more resonant frequencies of the cavity resonator. The high frequency supply may drive the cavity resonator at a suitable frequency and preferably at microwave frequencies.

The detector may further detect either directly or indirectly the Q of the cavity. From these measurements it may be inferred or calculated the composition of the fluid or other material flowing in through the cavity resonator. The system may also provide one or more outputs corresponding with the measured values or the composition of the fluid.

According to a second aspect there is provided a method of detecting properties of a fluid comprising the steps of: flowing the fluid through a cavity resonator having a fluid entrance and a fluid exit forming a fluid flow path through the cavity and a shorting plate within the cavity arranged within the fluid flow path; and detecting a resonant frequency of the cavity resonator.

Preferably, the method further comprises the step of detecting multiple resonant frequencies of the cavity resonator. These multiple frequencies or modes may be detected simultaneously and detect the real and imaginary permittivity of flowing fluid.

Optionally, the fluid may comprise different components.

Preferably, the properties of each component may be detected by measuring different resonant frequencies and/or the Q of the cavity resonator.

Optionally, the fluid may consist of any one or more of: oil; fuel; water; methanol; crude oil; aviation fuel; and diesel.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows cross-sectional schematic view of a cavity resonator, given by way of example only; and

FIG. 2 shows a sectional schematic view through line A-A of the cavity resonator of FIG. 1.

It should be noted that the figures are illustrated for simplicity and are not necessarily drawn to scale.

### DETAILED DESCRIPTION OF THE PREFERRED EMBODIMENTS

Information on the composition and physical characteristics of many materials may be determined from the dielectric response of these materials in the radiofrequency region of the electromagnetic spectrum. If a sample of such material is placed in a radiofrequency sensor, changes to the radiofrequency characteristics of the sensor will occur that are dependent on the dielectric response of the material. The dielectric response of a material is a complex parameter with both real and imaginary components. To characterise a material with improved certainty it is preferable to measure both components of its dielectric response. Known radiofrequency sensors such as capacitive sensors, measure a single parameter that is dependent on either one or commonly a combination of both real and imaginary components. An advantage of the present device is that it may be used to measure the individual components of the dielectric response of materials simultaneously. This offers improved sensitivity, selectivity and accuracy in sensing complex mixtures and fluids.

The radiofrequency characteristics of a radiofrequency resonant cavity sensor may be specified in terms of two parameters. These parameters may be a “lossless” parameter such as the resonant frequency or calculated reactance of the sensor and a “lossy” parameter that may be the Q-factor or Q of the sensor. These two parameters will be dependant upon and related to the real and imaginary components respectively of the dielectric response of a material placed within the resonant cavity. Therefore, measuring these parameters may provided information regarding the material.

Cavity resonators are radiofrequency sensors that may operate in the microwave region of the radiofrequency spectrum (typically between 300 MHz and 300 GHz or 1-10 GHz, for example). Cavity resonators are enclosed metal/conductive structures that are resonant at one or more modes within this frequency range. Radio Frequency (RF) energy can be coupled into a resonant cavity structure using a small antenna attached to a cable that connects through the wall of the cavity. Other suitable coupling means may be employed. The resonant frequency of these modes is primarily dependent on the physical dimensions of the structure and the material contained within the volume of the cavity.

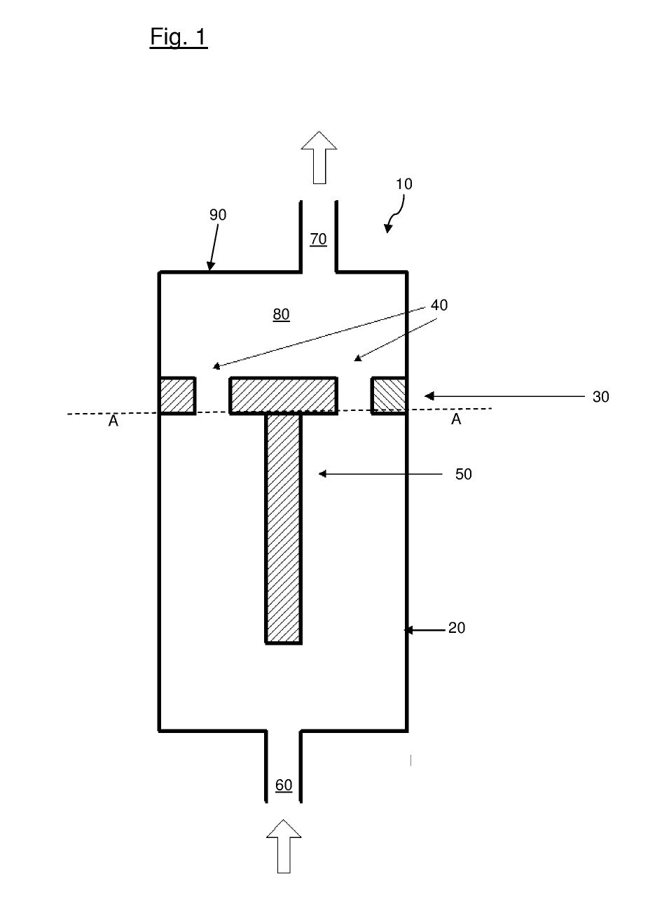

FIG. 1 shows a sectional view through a cavity or pipe resonator 10 typically used within a pipeline or other sensing environment. The body 20 of the cavity resonator is made from a conductive material or metal such as copper, aluminium or steel, for example. In this particular example, the cavity resonator 10 is cylindrical but other shapes may be used.

The cavity resonator 10 is a re-entrant coaxial resonator. In other words, the cavity resonator 10 further comprises a centre conductor 50 extending at least partially along an axis of the cavity. In the example shown in FIG. 1, the centre or inner conductor 50 is coaxial with the cylindrical body 20. Other forms of re-entrant cavities may be used, especially those described in “Cavity Resonators”—A. K. Sharma, pages 91-106 of “Wiley Encyclopaedia of Electrical & Electronics Engineering”, Wiley 1999.

A shorting plate 30 is fixed within the cavity resonator 10 to provide an electrical path joining the walls of the cavity resonator with the centre or inner conductor 50.

Holes or apertures 40 are formed within the shorting plate 30 to allow the flow of fluid through the cavity resonator 10. The size or diameter of the holes 40 may be such that a cut-off frequency for RF radiation through the holes 40 is significantly greater than a resonant frequency of the highest mode of the cavity resonator 10 being used in measurements. Furthermore, there should be sufficient material between the holes 40 in the shorting plate 30 to ensure that the short acts as a good short at each or all of the resonant frequencies used. There will be a small amount of penetration of RF energy through the shorting plate. To reduce end effects caused by this leakage of RF energy, a small “reservoir” 80 of fluid may be formed between the shorting plate 30 and an end 90 of the cavity resonator 10. Furthermore, the holes 30 should be large enough to allow sufficient flow of fluid through the cavity resonator 10.

As well as improving the electrical properties of the cavity resonator 10, the shorting plate 30 also provides additional mechanical strength, which may be important when considering the harsh environment (high temperatures and pressures) encountered especially in an oil well.

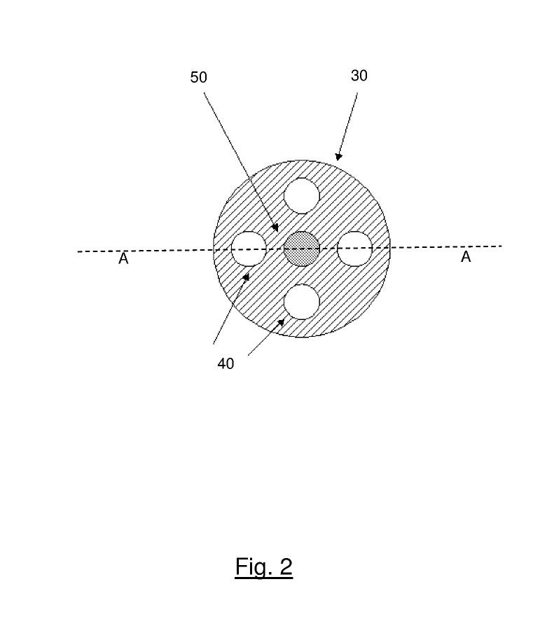

FIG. 2 shows a sectional view of the cavity resonator 10 through line A-A shown on FIG. 1. FIG. 2 shows a plan view of the shorting plate 30 including the location of the apertures 40 and the centre conductor 50.

The cavity resonator 10 may be constructed entirely out of metallic parts. Alternatively, an open-ended resonator may be formed with end plates 90 made from an insulating material such as plastic or ceramic, for example. The use of metal parts may provide further mechanical strength and lower the susceptibility to chemical attack. Preferably, the shorting plate 30 and centre conductor 50 may be made from the same material as the body 20 of the cavity resonator 10 to reduce thermal stresses caused by large changes in temperature of the fluid flowing through the device. The fluid may enter the device through fluid entrance or pipe 60 and leave through fluid exit or pipe 70. However, other configurations of fluid flow may be used.

An example use of the cavity resonator 10 described with reference to FIGS. 1 and 2, may be in-flow measurements of oil (for example crude oil) and its water content. The methanol content may also be measured. For a particular sized cavity resonator 10 it may be possible to excite more than one mode at for instance, 600 MHz, 1.8 GHz and 3 GHz. This makes it possible to interrogate a particular sample at a number of different frequencies either simultaneously or in an interleaved or multiplexed manner, which has particular advantages when investigating complex non-uniform fluid samples. This multi-modal sensing arrangement may also improve sensitivity and selectivity.

The use of multiple modes of the same resonator to take simultaneous measurements at different frequencies on a particular fluid, allows real-time sampling of a highly non-homogeneous fluid consisting of a number of complex components that may vary across a sample volume and change rapidly. This type of sensor also makes it unnecessary to provide a series of sensors at different spatial positions along a pipeline, each measuring a particular different component of the fluid.

The use of this cavity resonator 10 also makes analysis and interpretation of the measurements easier to achieve. In particular, the parameters of the resonant frequencies and the Q factor of the cavity may be measured at exactly the same moment in time and so provide more accurate measurements.

As will be appreciated by the skilled person, details of the above embodiment may be varied without departing from the scope of the present invention, as defined by the appended claims.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A cavity resonator comprising:
a cavity having a fluid entrance and a fluid exit forming a fluid flow path through the cavity; and
a shorting plate within the cavity arranged within the fluid flow path.

2. The cavity resonator of claim 1, wherein the shorting plate comprises one or more apertures for fluid to pass through.

3. (canceled)

4. The cavity resonator according to claim 1, wherein the cavity is cylindrical.

5. The cavity resonator according to claim 1 further comprising an inner conductor.

6. The cavity resonator of claim 5, wherein the inner conductor is coaxial with the cavity.

7. The cavity resonator of claim 5, wherein the inner conductor is in contact with the shorting plate.

8. (canceled)

9. The cavity resonator according to claim 1, wherein the shorting plate is annular.

10. (canceled)

11. The cavity resonator of claim 1 further comprising non-conductive end plates.

12. The cavity resonator according to claim 1, wherein the cavity resonator is configured to resonate at 600 MHz and above.

13. The cavity resonator according to claim 1, wherein the cavity resonator is configured to resonate at multiple frequencies.

14. A system for detecting properties of a fluid, the system comprising:
a cavity resonator comprising:
a cavity having a fluid entrance and a fluid exit forming a fluid flow path through the cavity; and
a shorting plate within the cavity arranged within the fluid flow path;
a fluid supply;
a radio or microwave frequency supply; and
a detector configured to detect one or more resonant modes of the cavity resonator.

15. A method of detecting properties of a fluid, the method comprising:
flowing the fluid through a cavity resonator having a fluid entrance and a fluid exit forming a fluid flow path through the cavity and a shorting plate within the cavity arranged within the fluid flow path; and
detecting one or more modes of the cavity resonator.

16. The method of claim 15 further comprising: detecting multiple modes of the cavity resonator.

17. The method of claim 15, wherein detecting comprises measuring either or both the frequency and amplitude of the resonant modes.

18-19. (canceled)

20. The method according to claim 15, wherein the fluid consists of any one or more of: oil; fuel; water; methanol; crude oil; aviation fuel; and diesel.

21. The system of claim 14, wherein detection comprises a measurement of either or both the frequency and amplitude of the resonant modes.

22. The system of claim 21, wherein the frequency and amplitude of at least one resonant mode are measured simultaneously.

23. The system according to claim 14, wherein the fluid comprises different liquid, solid, or gaseous components.

24. The system of claim 23, wherein properties of the different components are detected by measuring different resonant modes of the cavity resonator.

25. The system according to claim 14, wherein the fluid consists of any one or more of: oil; fuel; water; methanol; crude oil; aviation fuel; and diesel.
